(19) United States
(12) Patent Application Publication
(10) Pub. No.: US 2014/0139155 A1
(43) Pub. Date: May 22, 2014

(54) METHOD AND DEVICE FOR CONTROLLING A RELUCTANCE ELECTRIC MACHINE

(71) Applicant: Sebastien Desharnais, Maurepas (FR)

(72) Inventor: Sebastien Desharnais, Maurepas (FR)

(73) Assignee: RENAULT S.A.S., Boulogne-Billancourt (FR)

(21) Appl. No.: 13/984,677

(22) PCT Filed: Jan. 30, 2012
(86) PCT No.: PCT/FR2012/050187

§ 371 Date: Feb. 5, 2014

(30) Foreign Application Priority Data
Feb. 9, 2011 (FR) 11 51040

(51) Int. Cl. H02P 21/00

(52) U.S. Cl. CPC H02P 21/0003
USPC 318/400.02

(57) ABSTRACT

In a method of controlling a reluctance polyphase electric machine, or an automobile motor, currents injected into each coil of a stator of the machine are deduced by a transformation of a pair of excitation currents and of armature current defined in a reference frame rotating with the rotor of the machine, such that: the excitation current is composed of a fundamental sinusoidal signal, to which are added successively other odd harmonics of increasing order when a torque setpoint of the machine increases, and the armature current is a signal proportional to the estimated or measured electromotive force of the machine.

The subject of the invention is a method for controlling an electrical machine, called a synchronous reluctance machine, and an electrical machine fitted to be able to be controlled according to this method.

A synchronous reluctance electrical machine comprises a series of stator windings defining poles of the machine and a rotor made of ferromagnetic material which has been structured for example with a series of notches, in order to make it easier to establish a magnetic field inside the rotor in certain particular directions.

The rotor may furthermore consist of a layered structure in order to limit the flow of electrical currents inside the rotor.

Such machines are often less costly to produce than machines of which the rotor comprises windings or permanent magnets. The maximum torque that it is possible to obtain for a given intensity of current depends in particular on the method of control.

Specifically, the mechanical power developed by an electric motor is proportional to the product of the current injected into the stator windings of the motor, by the electromotive force induced in these windings by the rotation of the rotor.

However, the electromotive force of an electrical machine is not always sinusoidal. The electromotive force of a machine supplied by a sine wave current is often square.

In order to optimize the power or the torque delivered by the machine, it would be necessary to be able to supply the machine with a current of the same profile as the electromotive force. By injecting a sine wave current, only the fundamental of the electromotive force is used, the other harmonics of the electromotive force not being used and degrading the power factor of the machine.

In the case of a reluctance machine, the electromotive force depends not only on the rotation speed of the rotor, but also depends on the shape of the currents injected into the windings.

To increase the torque delivered by the machine, it is therefore possible to be tempted to supply the machine with current signals of rectangular shape. Such a method of control however poses several problems:
the losses known as “iron loss”, corresponding to the appearance of current that does not contribute to the generation of torque, are high in the case of a supply by current signals of rectangular shape,
the optimality of a rectangular-current signal is relative because the magnetic field along the air gap between the rotor and the stator cannot be exactly rectangular,
since a rectangular signal is divided into many harmonics, the interactions of these various harmonics can generate vibrations and noise when the motor operates.

For want of exciting the motor by a rectangular current, certain documents, such as patent application JP 61 00 1294, propose to inject harmonic signals of current in addition to a sine-wave fundamental current signal in order to generate more power for a given voltage. U.S. Pat. No. 5,189,357 therefore proposes to excite a synchronous machine by a sine-wave signal on which a harmonic of order 3 of the first signal is superposed.

U.S. Pat. No. 6,674,262 proposes to inject a complex signal consisting of a fundamental and of a series of harmonics of which the amplitude is determined by fine tuning during the design of the machine.

The solutions proposed above propose an a priori injected current profile, but do not propose to take account of the real profile of the signal of electromotive force. Moreover, the shape of the injected current signal is similar for the low torques as for the high torques, which is capable of generating unnecessary iron losses at low torques, and, for the greater current amplitudes, of limiting the torque that the machine could supply.

The object of the invention is to improve the control of an electrical machine, notably of a reluctance electrical machine, so as to make it possible both to limit the iron losses at low torques, and, for one and the same maximum amplitude of current allowed by the supply electrical circuits, to obtain a greater torque or mechanical power of the machine.

Accordingly, in a method for controlling a reluctance polyphase electrical machine, notably a motor for a motor vehicle, the currents injected into each coil of the stator of the machine are deduced by a transformation similar in its principle to a transformation of Concordia-Park type of a pair (Id, Iq) of excitation currents Id and of armature current Iq defined in a reference frame (d, q) rotating with the rotor of the machine, such that:
the excitation current (Id) consists of a fundamental sine wave signal, to which are added in turn other odd harmonics of increasing order when the torque setpoint of the machine increases,
the armature current (Iq) is a signal proportional to the estimated or measured electromotive force of the machine.

According to a preferred embodiment, when the torque setpoint of the machine increases, the amplitude of the harmonic of highest order amongst the harmonics effectively present of the excitation current is increased until this amplitude reaches a threshold amplitude associated with the order of the harmonic, while keeping constant the amplitude of the lower-order harmonics of the excitation current.

When the torque setpoint increases further and the amplitude of the harmonic of the highest order reaches the threshold amplitude associated with the order of the harmonic, a higher-order harmonic signal is added to the excitation current.

Advantageously, the composition of the signal of excitation current (Id) is determined on the basis of a first mapping linking the torques of rotation speed and of setpoint torque (N, C) of the machine, and lists of amplitudes to be applied to the fundamental and to the various odd harmonics comprising the excitation current (Id).

Preferably, the amplitudes of the odd harmonics are chosen such that the excitation current Id becomes ever closer to a rectangular signal as the torque setpoint (C) increases.

According to a preferred embodiment, the pulsation (ω) of the fundamental of the excitation signal is equal to the pulsation (Ω) of the machine multiplied by the number of pairs of poles of the machine, and the rotation speed of the reference frame (d, q) in which the excitation current (Id) and the armature current (Iq) are calculated is equal to the rotation speed of the rotor of the machine.

The phase of the excitation signal (Id) is preferably chosen such that this signal (Id) is maximum when an axis of minimum reluctance (d) of the machine rotor is aligned with the axis of one of the coils of the stator of the machine. “Minimum reluctance axis” means one of the radial directions of the rotor along which the induction magnetic field is locally maximal relative to the adjacent directions for a given excitation field.

According to one possible embodiment, the amplitude of the armature current (Iq) is chosen such that an effective value of the armature current (Iq) is equal to an effective value (Id) of the excitation current.

According to another embodiment, the amplitude of the armature current (Iq) is determined by means of a second mapping that is a function of the torque (C) of the setpoint of the machine and of the rotation speed (N) of the machine.

The method may be applied to the controlling of a reluctance electrical machine with diametral winding. The estimated electromotive force of the machine is then preferably filtered so as to count only the electromotive force that is self-induced by each winding of the stator, while excluding the terms of mutual inductions between the various windings.

The method may also be applied to the control of a reluctance electrical machine with tooth winding. In this application, the harmonics of a gear-teeth frequency are then excluded from the armature-current signal (Iq), the gear-teeth frequency being equal to the number of winding teeth multiplied by the frequency of rotation of the rotor of the machine.

According to another aspect, a subject of the invention is a reluctance electrical machine fitted with a means for estimating the angular position of the rotor of the machine, with a means for determining the electromotive force of the machine, and with a control unit. The control unit is configured to compute the currents to be injected into the various coils of the stator of the machine, by a change of rotating reference frame based on a first excitation-current signal, mapped as a function of a torque setpoint of the machine and of the estimated speed of rotation of the rotor, and based on a second armature-current signal proportional to the electromotive force estimated or measured by the determination means.

Advantageously, the means for determining the electromotive force comprises a winding of one or more conductive turns not supplied with electric current, wound so as to be traversed by the same magnetic flux as one of the coils of the stator of the machine, the winding being fitted with a sensor of the voltage generated between its two ends.

An electrical machine according to the invention may therefore be fitted with a winding of one or more conductive turns not supplied with electric current, wound so as to be traversed by the same magnetic flux as one of the coils of the stator of the machine. It can then be fitted with a sensor capable of measuring the voltage generated between the two ends of the winding, and fitted with a control unit configured to compute the currents to be injected into the various coils of the stator of the machine, by a change of rotating reference frame based on a first excitation-current signal, mapped as a function of a torque setpoint of the machine and of the estimated rotation speed of the rotor, and based on a second armature-current signal proportional to a filtered value of the voltage between the ends of the winding.

Preferably, the sensor of voltage at the terminals of the winding is offset or is electrically isolated from the portion of the control unit computing the currents to be injected.

The electrical machine thus fitted can be a reluctance electrical machine of which the winding of the stator is a tooth winding.

According to another variant embodiment, the electrical machine thus fitted can be a reluctance electrical machine of which the winding of the stator is a winding of diametral type.

A reluctance electrical machine with tooth winding can be fitted with a means for estimating the angular position of the rotor of the machine, fitted with a winding of one or more conductive turns not supplied with current and wound so as to be traversed by the same magnetic flux as one of the coils of the stator of the machine, fitted with a sensor capable of measuring the voltage generated between the two ends of the winding, and fitted with a control unit. The control unit may be configured to compute the currents to be injected into the various coils of the stator of the machine, by a change of rotating reference frame based on a first excitation-current signal, mapped as a function of a torque setpoint of the machine and of an estimated rotation speed of the rotor, and of a second armature-current signal proportional to a filtered value of the voltage between the ends of the winding. The control unit may then be configured to exclude from the armature current the multiple frequencies of the gear-teeth frequency, the gear-teeth frequency being equal to the number of winding teeth multiplied by the frequency of rotation of the rotor of the machine.

Other objects, features and advantages of the invention will appear on reading the following description, given only as a nonlimiting example and made with reference to the appended drawings in which:

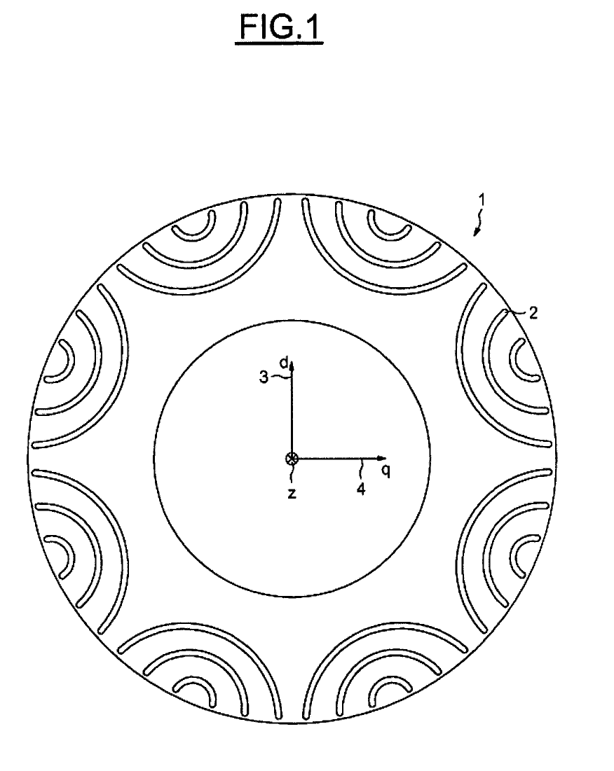

FIG. 1 illustrates schematically the geometry of a rotor of a sine synchronous reluctance machine,

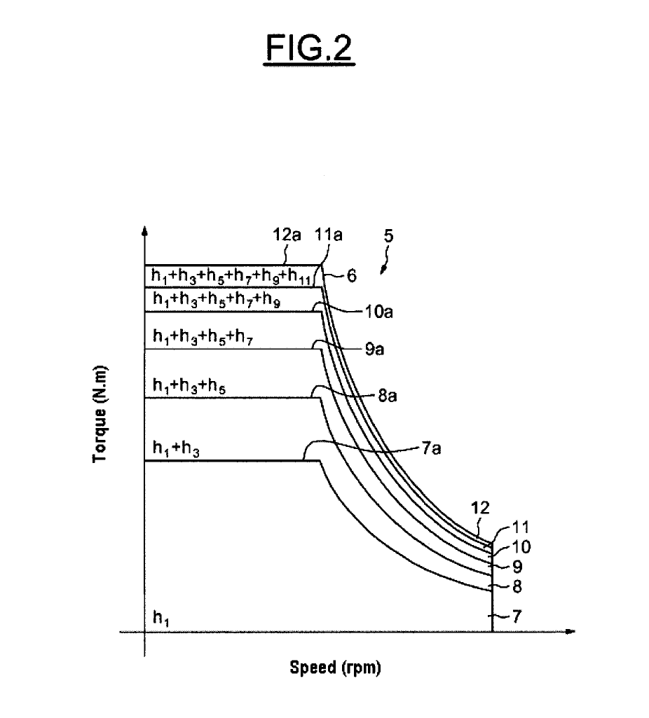

FIG. 2 is an example of mapping used for the control method according to the invention,

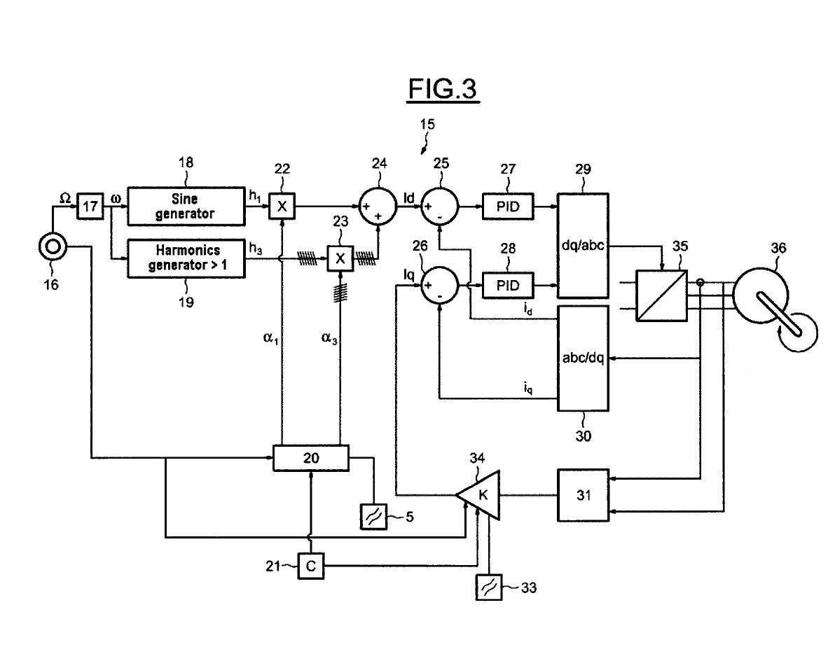

FIG. 3 illustrates schematically a device according to the invention designed to control a reluctance motor,

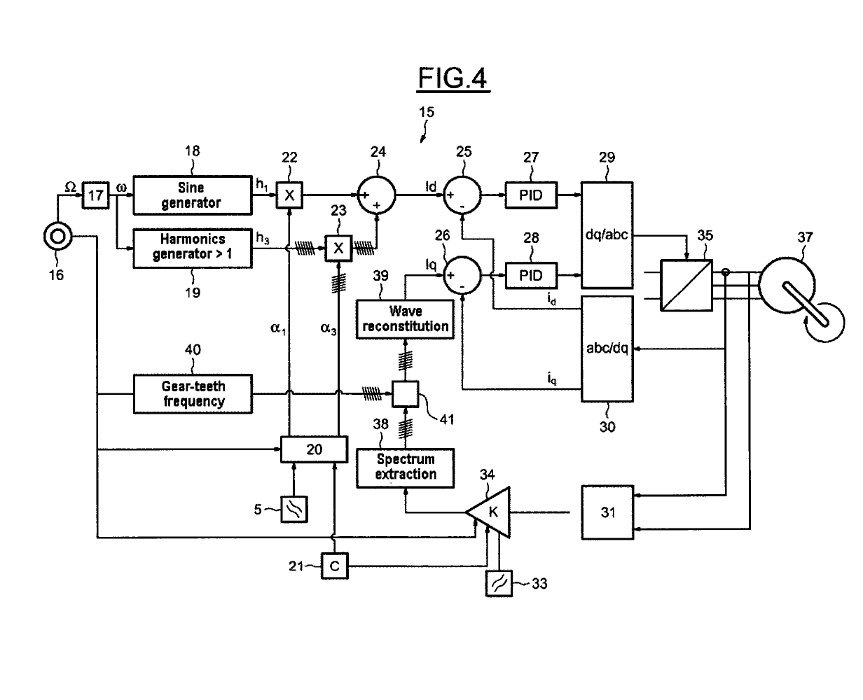

FIG. 4 illustrates schematically a device according to the invention designed to control a reluctance motor with tooth winding,

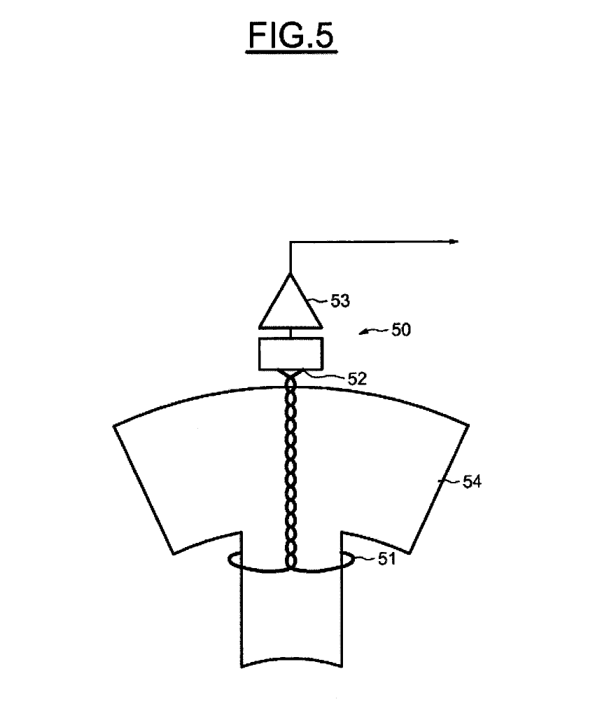

FIG. 5 illustrates a sensor used in the context of a control method according to the invention.

FIG. 1 illustrates a typical geometry of a rotor of a reluctance machine called a “sine synchronous reluctance machine”.

In this instance the rotor is shown in a plane perpendicular to an axis Z of axial symmetry of the rotor.

The mass of the rotor 1, made of ferromagnetic material, is notched by notches 2 defined by portions of curved surfaces of generatrices parallel to the axis z. In the example illustrated, the contours of the notches 2 are defined by portions of a cylinder centered on axes external to the external circumference of the rotor 1.

The end of the notches 2 approaches, without joining the external circumference of the rotor 1. The notches 2 delimit directions of lesser reluctance along which a magnetic field induced inside the rotor 1 tends to be oriented. Such a minimum reluctance axis is for example identified by the axis 3, or the axis d, of FIG. 1. An axis q, referenced 4, perpendicular to both the axis d and to the axis of revolution z, is also shown in FIG. 1 so as to obtain an orthonormal reference frame d, q, z. The reference frame d, q is centered on the rotation axis of the rotor.

The interaction of the magnetic fields induced inside the ferromagnetic material forming the rotor 1, and of the magnetic field induced in the air gap between the rotor 1 and the stator coils (not shown) of the electrical machine (not shown) make it possible to create the rotation torque of the machine.

In the control method according to the invention, the stator currents (Id, Iq) are defined to be injected into the coils of an equivalent two-phase machine, representing the real machine with any number of phases more than 2, provided that there is a change of reference frame. Moreover, in order to compute the currents of the equivalent machine, the adopted situation is that of a reference frame rotating at the same speed as the rotor of the real machine (change of reference frame commonly called “Park transform”). Through misuse of language, the rotating reference frame, in the space of currents, is similar to the geometric reference frame (d, q) linked to the rotor, because the two reference frames rotate at the same speed.

The intensities of current injected into each of the stator coils of the real machine are therefore deduced by a change of reference frame making it possible to change from a current system with n phases, for example with three phases, to a two-phase (Id, Iq) current system, and vice versa. The values of current to be injected into each of the coils of the stator are therefore defined as soon as the two signals Id and Iq of the equivalent bipolar system are determined.

The values of current Id and Iq are defined in the following manner. The current Id, the excitation current, is defined a priori as a function of the operating domain (torque, rotation speed) of the electrical machine, so as to create an initial magnetic field in the rotor 1. For torque setpoints that are not very high, this excitation current is a simple sine wave signal of which the pulsation is equal to the pulsation of rotation of the rotor, multiplied by the number of poles of the electrical machine. The advantage of such a sine wave signal, relative to a rectangular signal, is to limit the losses called “iron losses” associated with the dissipative current generated in the rotor.

As the torque setpoint increases, odd harmonics are superposed on the first fundamental signal so that the signal Id comes closes to a rectangular signal. It is therefore possible to obtain a greater torque supplied by the machine, relative to the sine-wave signal alone, for one and the same maximum value of intensity passing through the electrical wires.

Specifically, the harmonics of high rank generate more loss per eddy current than the harmonics of lower rank, but contribute more to the conversion of electrical energy into torque, proportionally to their amplitude, than the harmonics of lower rank.

The composition of the excitation signal Id can be defined based on mapping, as illustrated in FIG. 2.

FIG. 2 illustrates in a simplified manner a mapping 5 linking a two-dimensional domain (of the rotation speed and machine torque axes) to several families of excitation signals. The mapping 5 shows an x axis representing the rotation speed of the electrical machine, that is to say the rotation speed of its rotor relative to the stator, and a y axis representing a torque setpoint of the machine.

Between the x axis, the y axis and a boundary 6 representing the operating limits of the machine, the operating domains 7, 8, 9, 10, 11, 12 are defined each corresponding to a different composition of the excitation signal Id.

The operating domains 7, 8, 9, 10, 11, 12 are defined inside the operating domain limited by the boundary 6, the switching from one domain to the highest-numbered domain being carried out either by increasing the setpoint torque, or by increasing the rotation speed of the machine. Each of these domains is limited in the upper portion by a plateau, respectively 7a, 8a, 9a, 10a, 11a and 12a, parallel to the limiting plateau 12a at the top, the operating domain delimited by the boundary 6.

Inside the domain 7, the excitation signal, marked hi in a simplified manner is a sine-wave signal.

For example, Id=hi=αi sin rot

where ω is the pulsation of rotation of the rotor multiplied by the number of poles of the machine.

The amplitude αi of the signal hi increases as a function of the torque, between the domain of the low torques adjacent to the x axis and the upper boundary of the domain 7. At the top, the domain 7 is limited, at the moderated speed values, by a plateau 7a for which the amplitude ai reaches a maximum value a₁ₘ.

On the right of the boundary of the domain 7, the amplitude ai can possibly achieve a value below a₁ₘ.

The mapping 5 shown, in this instance in a simplified manner, allocates to each point defined by its coordinates (speed, torque) of the domain 7, a value ai.

The domain 8 represents an operating domain of the machine in which the injected signal Id consists of a sine-wave signal hi, for example the signal hi corresponding to the points of the same speed situated on the top boundary of the domain 7, and a signal h₃ which is a harmonic signal of order 3 of the signal h₁, of amplitude a₃, namely h₃=a₃ sin 3 ωt.

The mapping 5 allocates to each point (speed, torque) of the domain 8 a torque of value (ai, a₃) representing the amplitudes of the fundamental signal and of the harmonic signal of order 3, making up the signal Id.

According to a preferred embodiment, the amplitude ai is constant for each vertical line inside the domain 8 and the amplitude a₃ increases with the setpoint torque. The amplitude ai may have a constant value a₁ₘ along the plateau 7a defining the top boundary between the domains 7 and 8.

Similarly, the mapping 5 defines for each point (speed, torque) of the domain 9, a triplet of amplitude values (a₁, a₂, α₃) making it possible to define a signal Id=h₁+h₃+h₅=ai sin cût+a₃ sin 3cût+a₅ sin 5cût.

Inside the domain 10, a harmonic h₇ of order 7, of amplitude a₇, is added to the previous harmonics. A domain 11, in which the signal Id includes a harmonic h₉ of order 9, and a domain 12 in which the signal Id includes a harmonic h₁₁ of order 11, can be defined. According to the embodiments, it is of course possible to limit the composition of Id to the harmonics of an order lower than or equal to 3, to 5, to 7 or to 9.

According to a variant embodiment, it is possible to define a simplified mapping 5 in the following manner.

The domains 7, 8, 9, 10, optionally 11 and 12, can be limited only by a top plateau, respectively 7a, 8a, 9a, 10a, 11a, 12a, inside the operating domain delimited by the boundary 6. The height of the plateau 7a is given by the maximum amplitude allowed for the injected current. This maximum amplitude defines a value a₁ₘ of the fundamental signal. To this amplitude a₁ₘ are associated amplitudes a₃ₘ, α₅ₘ, . . . so that the signal a₁ₘ sin cût+a₃ₘ sin 3cût+a₅ₘ sin cût+ . . . converges progressively on a rectangular signal as the harmonics of higher order are added. Once the top boundary of the domain 7a is reached, the harmonic of rank 3 starts to be added with an amplitude that increases between 0 at the level of the boundary 7a and its maximum value a₃ₘ at the level of the boundary 8a.

The height of the plateau 8a is defined by the torque that can be obtained with the aid of the signal Id=a₁ₘ sin cot+a₃ₘ sin 3 cot.

If the torque setpoint increases from the value of the plateau 8a, a harmonic component of rank 5 of which the amplitude is made to increase until the value of the setpoint torque reaches the plateau 9a is added to the signal Id. The height of the plateau 8a is defined by the torque that can be obtained with the aid of the signal Id=a₁ₘ sin cût+a₃ₘ sin 3cût+a₅ₘ sin 5cût.

Once the shape of the signal Id has been defined with the aid of the mapping 5, the injection of the excitation current Id, reconverted by the transform into a phase current for each coil of the electrical machine, generates an electromotive force (FEM). This electromotive force is estimated in order to inject a second component of current Iq, or armature current, which is, at the first approximation, proportional to this electromotive shape. The armature current Iq is the current injected on the second phase of the equivalent two-phase machine. Iq is the current of this equivalent machine along the second axis of the rotating reference frame of the transformation.

This armature current Iq is constructed so as to have a profile similar to or proportional to the electromotive force of the machine, by eliminating as required the frequencies that could cause instabilities of the regulation system.

FIG. 3 illustrates schematically a device 15 for controlling a reluctance electrical machine 36 according to the invention. A reluctance machine 36 is furnished with a sensor 16 of the position of its rotor. The position sensor 16 may be a sensor of the inductive or optical type, and may, depending on the variant embodiments, be replaced by a position estimator capable of recomputing the position of the rotor as a function of the currents and of the voltages at the terminals of the various coils. The position sensor 16 is used to define a pulsation Ω which is equal to 2πχN, where N is the number of rotations per second that the rotor makes.

The pulsation Ω is converted, in an electrical-pulse estimator 17, into electrical pulses ω, where ω is equal to Ω multiplied by the number of pairs of poles of the electrical machine 36. The electrical pulsation ω is then sent to a sine generator 18 and to one or more harmonic generators 19. The sine generator 18 generates a signal of the sin(cot) type and the harmonic generator(s) 19 each generate a harmonic of the signal generated by the sine generator 18. One first harmonic generator 19 can therefore deliver a signal sin(3 cot), a second harmonic generator 19 can deliver a signal sin(5 cot), a third harmonic generator can deliver a signal sin(5 cot).

In order to simplify the figure, a single harmonic generator has been shown.

Signals from the sine generator 18 and from the harmonic generator(s) 19 are sent respectively to multipliers 22 and 23. An excitation spectrum selector 20 receives as an input a value representative of the rotation speed of the machine which for its part is transmitted by the rotor-position sensor 16, and also receives a torque-setpoint value C which for its part is transmitted by a torque-setpoint generator 21, which takes account of the commands of the driver and various strategies for optimizing driving of the vehicle of which the driving wheels are driven by the machine 36.

The excitation spectrum selector 20 is connected to the mapping 5 described in FIG. 2, and as a function of the pair of values of rotation speed and of torque setpoint (N, C) of the machine 36, delivers the values α₁, a₃, a₅, . . . of amplitudes which it sends respectively to the multiplier 22 and to the multiplier(s) 23. The outputs of the multiplier 22 and of the multiplier(s) 23 are sent to a summer 24 of which the output is the excitation current Id. The excitation current Id is sent to the positive input of a subtractor 25 of which the output is sent to a PID regulator 27. The output of the PID regulator 27 and the output of a second PID regulator 28 are sent to a translator 29. The translator 29 converts the two values originating from the regulators 27 and 28, considered to be current coordinates, in the rotating reference frame (d, q) of the equivalent two-phase machine, into three values representing the currents supplying each coil of the real machine 36, in a reference frame abc associated with three phases of the real coils. The translator 29 therefore delivers one setpoint value per winding a, b or c of the machine 36, a setpoint which is transformed into a supply-current signal by an inverter 35. A second translator 30 receives as an input the current value entering one of the phases of the machine 36, deduces therefrom, by transformation, the current coordinates of the three phases in the fixed three-phase current reference frame of the real machine, and converts these values into a pair of current values (id, i_{q}) corresponding to the currents injected into the equivalent two-phase machine, respectively along the axis d and along the axis q. These “measured” values of phase currents of the equivalent machine are subtracted in the subtractors 25 and 26, respectively from two setpoint values Id and Iq arriving at the positive inputs of these two subtractors, before being sent to the PID regulators 27 and 28. The generation of the setpoint signal of excitation current Id has been described above. The generation of the setpoint signal of armature current Iq is carried out as follows.

An estimator 31 of electromotive force is connected to the terminals of one of the coils of the machine 36. Based on measurements of voltage and/or of current at the terminals of this coil, the estimator 31 of electromotive force estimates the electromotive force developed by the machine 36. According to the variant embodiments, the estimator of electromotive force can be replaced by a sensor of electromotive force placed in parallel with one of the coils, so as to measure directly the flux passing through the coil. The electromotive-force signal estimated by the estimator 31 is sent to an amplifier 34 which is connected to the position sensor 16 and the torque-setpoint generator 21. The amplifier 34 is connected to a mapping 33 making it possible to define, on the basis of the rotation speed of the machine transmitted by the position sensor 16 and on the basis of the torque setpoint C transmitted by the torque-setpoint generator 21, an amplitude A(N, C) that is desired for the armature current Iq.

The amplifier 34 multiplies the electromotive-force signal of the estimator 31 by an appropriate coefficient so as to obtain a signal Iq of which the amplitude is equal to the value A(N, C) originating from the mapping 33. “Amplitude of the signal” can, for example, be understood to be the effective value of the signal, that is to say the average, over a period of the signal, of the absolute value of the signal. According to the embodiments other ways of defining the amplitude are also possible, for example an average value of the square of the signal over a period.

According to one advantageous variant embodiment, the amplifier 34 may not be connected either to the position sensor 16 or to the torque-setpoint generator 21, but receive as an input the signal Id delivered at the output of the summer 24. The amplifier 34 may then be configured to compute the amplitude of this signal Id, the amplitude of the electromotive force originating from the estimator 31, and to multiply the signal of electromotive force originating from the estimator 31 so as to obtain a signal Iq proportional to the electromotive force, and of amplitude equal to a predefined multiple of the signal Id of excitation current. The predefined multiple may, for example, take the value 1. The signal Iq originating from the amplifier 34 is sent to the positive input of the subtractor 26.

It is noted that the signal Id of excitation current is constructed as an open loop based on the mapping 5, and the signal Iq of armature current is constructed as a closed loop based on the estimate of electromotive force measured on the machine. The pair of signals (Id, Iq) make up a resultant signal making it possible to determine, provided that there is regulation by the regulators 27 and 28, the currents by which the inverter 35 supplies each phase of the machine 36.

In order to prevent instabilities of the regulation system, the estimator 31 of electromotive force can be designed so as to eliminate from the signal Iq any terms of mutual inductance between the various coils of the machine 36. These terms may be particularly important in the case of a machine with diametral winding, where each coil encompasses a diameter of the stator, each coil being wound, so to speak, in the extension of an adjacent coil.

If the machine 36 is a machine with diametral winding, the estimator 31 of electromotive force will preferably be designed so as to transmit to the amplifier 34 a value of electromotive force from which the terms associated with the mutual inductance between the coils will have been deduced. The estimator 31 may, for example, measure the current and the voltage at the terminals of a coil a, estimate the electromotive force eₐ associated with the coil a, and subtract therefrom the terms of mutual inductance

$${L}_{a} b \frac{d {i}_{b}}{d t}$$

$$and$$

$${L}_{ac} \frac{d {i}_{c}}{d t} c ,$$

where Lₐb and L_{ac} are mutual inductances between the coils a and b and the coils a and c,
i_{b} is the current in the coil b and i_{c} is the current in the coil c.

FIG. 4 illustrates schematically another control device according to the invention. FIG. 4 contains elements common to FIG. 3, the same elements then bearing the same references. FIG. 4 illustrates a device specially adapted for a reluctance machine 37 with tooth winding. In the case of a machine with tooth winding, the current signals of which the frequency is proportional to a frequency f_{d}, called “gear-teeth frequency” risk causing instabilities of the regulation system. The aim is therefore to eliminate these frequencies from the signal Iq injected as armature current.

The gear-teeth frequency is equal to the number of winding teeth of the machine 37, multiplied by the speed N of rotation of the rotor of the machine. So as to reject only these frequencies, the device of FIG. 4 proposes to proceed as follows: the normalized signal originating from the amplifier 34, proportional to the electromotive force delivered by the estimator 31, is sent to an FFT (Fast Fourier Transform) converter 38 which extracts a discrete spectrum of the signal originating from the amplifier 34.

A gear-teeth frequency generator 40, which receives as an input the rotation speed delivered by the position sensor 16, transmits the gear-teeth frequency, of which the harmonics are to be avoided, to a frequency filter 41. The frequency filter 41 receives as an input the spectrum delivered by the FFT converter 38, excludes therefrom the frequency delivered by the generator 40 and its harmonics, and sends the remaining spectrum to a wave generator 39 which thus reconstructs a signal corresponding to the signal delivered by the amplifier 34, stripped of the gear-teeth frequency and its harmonics. This reconstituted signal is sent to the positive input of the summer 26 as a value of armature-setpoint current Iq.

The use of the regulation method according to the invention in order to control a reluctance machine with tooth winding is particularly advantageous. The method makes it possible to obtain performances at maximum torques comparable to those that it is possible to have for a machine with diametral winding which is markedly more costly to produce. At low torques, the method makes it possible to limit the losses in efficiency through iron losses.

FIG. 5 illustrates a sensor of electromotive force specially suited to the invention and able to be used instead of the estimator 31 of FIGS. 3 and 4. The estimators of electromotive force that are commonly used are usually based on measurements of current and of voltage at the terminals of one or more coils of the machine. Such estimators make it necessary to have a reliable model of the machine and to dedicate a certain computing power to the estimation of the electromotive force.

An alternative solution is to estimate the electromotive force associated with a coil by measuring directly the flux passing through the coil. It is possible to envisage, for this, placing a field sensor inside the coil. The local field sensors, which are usually Hall effect sensors, are costly and give only a very local image of the field and/or of the magnetic flux inside the coil.

A preferred variant of a device according to the invention proposes to put in place, as illustrated in FIG. 5, one or more conductive turns 51, which are wound during the manufacture of the stator parallel with one of the coils of the stator, but are not thereafter supplied with current. In FIG. 5, the turn 51 is therefore wound around a winding tooth belonging to a rotor segment of a reluctance machine with tooth winding. This or these turns 51 are therefore traversed by the whole of the flux passing through the coil, and the ends 52 of the winding comprising these turns 51 are connected to an amplifier 53, itself connected to a voltage sensor (not shown) which delivers a voltage directly proportional to the electromotive force associated with the coil.

The factor of proportionality between the voltage between the ends 52 and the electromotive force is equal to the ratio of the number of turns of the winding 51 and of the number of turns of the coil. A winding with a single turn may be sufficient, but a winding with several turns, made of thin wire, can make it possible to refine the estimation of the electromotive force for low torques. The voltage sensor used to measure the voltage at the terminals of the winding is preferably insulated from the computing unit driving the inverter 35 so as not to risk disrupting the electronics of the computer.

The amplifier 53 must have a very high input impedance in order to limit as much as possible the current flowing in the winding which would then disrupt the field that it is intended to measure. Using such a sensor of electromotive force limits the computing power necessary for the system and increases the accuracy of the estimate of the electromotive force.

The subject of the invention is not limited to the exemplary embodiments described and may take the form of many variants. The control method described may be applied to electrical machines other than reluctance electrical machines with diametral winding or with tooth winding, for example to a synchronous machine with wound rotor or a switched reluctance machine.

The way of composing the excitation signal Id may be different from that described. The mapping 5 may fix the amplitudes of the harmonic signals of lower order when a harmonic signal of higher order is introduced. It may also depart from this rule by modulating the relative amplitudes of the various harmonics as a function of the space domain (speed, torque).

The estimator or the sensor of electromotive force 31 may be based on a measurement taken at the terminals of a single coil or at the terminals of a single sensor associated with a coil. The estimator or the sensor 31 may, according to another variant, take into account measurements taken at the terminals of each of the coils of the machine.

In the case of a machine with diametral winding, the elimination of the terms of mutual inductance may be carried out by subtracting, in a linear manner, the crossed inductance terms proportional to the currents flowing in the other two phases (in the case of a three-phase machine). According to another variant embodiment, the elimination of the terms corresponding to the mutual inductances may be carried out by a method of correlation of the currents of the various phases. By eliminating the terms correlated between two phases, it is thus possible to eliminate the terms associated with the mutual inductance, which risk disrupting the stability of the regulation system.

The control method according to the invention, by virtue of the taking account, in real time, of the shape of the signal of electromotive force, makes it possible both to limit the iron losses for the low torques of the machine, and to optimize the maximum torque that can be obtained relative to the maximum amplitudes of current that are authorized for the machine. The gain in terms of maximum available torque is particularly high in the case of a machine with tooth winding. In the case of a machine with diametral winding, the relative gain in torque is less, but remains worthwhile. In conclusion, with the control method according to the invention, the performance of the machines with tooth winding and diametral winding become comparable, while the machine with tooth winding usually proves to be less efficient in the case of control methods that do not take account, in real time, of the shape of the signal of electromotive force of the machine.

1-18. (canceled)

19. A method for controlling a reluctance polyphase electrical machine, or a motor for a motor vehicle, comprising:
deducing currents injected into each coil of a stator of the machine by a transformation of a pair of excitation currents and of armature current defined in a reference frame rotating with the rotor of the machine, such that:
the excitation current includes a fundamental sine wave signal, to which are added in turn other odd harmonics of increasing order when a torque setpoint of the machine increases, and
the armature current is a signal proportional to estimated or measured electromotive force of the machine.

20. The control method as claimed in claim 19, wherein, when the torque setpoint of the machine increases, an amplitude of a harmonic of highest order amongst harmonics effectively present of the excitation current is increased until the amplitude reaches a threshold amplitude associated with the order of the harmonic, while keeping constant amplitudes of lower-order harmonics of the excitation current.

21. The control method as claimed in claim 20, wherein, when the torque setpoint increases and the amplitude of the harmonic of highest order reaches the threshold amplitude associated with the order of the harmonic, a higher-order harmonic signal is added to the excitation current.

22. The control method as claimed in claim 19, wherein a composition of the signal of excitation current is determined on the basis of a first mapping linking torques of rotation speed and of the setpoint torque of the machine, and lists of amplitudes to be applied to a fundamental and to various odd harmonics comprising the excitation current.

23. The control method as claimed in claim 19, wherein the amplitudes of odd harmonics are chosen such that the excitation current becomes ever closer to a rectangular signal as the torque setpoint increases.

24. The control method as claimed in claim 19, wherein pulsation of a fundamental of the excitation signal is equal to pulsation of the machine multiplied by a number of pairs of poles of the machine, and a rotation speed of the reference frame in which the excitation current and the armature current are calculated is equal to a rotation speed of a rotor of the machine.

25. The control method as claimed in claim 19, wherein a phase of the excitation signal is chosen such that the excitation signal is maximum when an axis of minimum reluctance of the machine rotor is aligned with an axis of one of coils of a stator of the machine.

26. The control method as claimed in claim 19, wherein an amplitude of the armature current is chosen such that an effective value of the armature current is equal to an effective value of the excitation current.

27. The control method as claimed in claim 19, wherein an amplitude of the armature current is determined by a second mapping that is a function of torque of the setpoint of the machine and of a rotation speed of the machine.

28. The control method as claimed in claim 19, applied to controlling a reluctance electrical machine with diametral winding, wherein the estimated electromotive force of the machine is filtered to count only electromotive force that is self-induced by each winding of a stator, while excluding terms of mutual inductions between various windings of the stator.

29. The method as claimed in claim 19, applied to control of a reluctance electrical machine with tooth winding, wherein harmonics of a gear-teeth frequency are excluded from the armature-current signal, the gear-teeth frequency being equal to a number of winding teeth multiplied by frequency of rotation of a rotor of the machine.

30. A reluctance electrical machine comprising:
means for estimating angular position of a rotor of the machine;
means for determining electromotive force of the machine; and
a control unit configured to compute currents to be injected into various coils of a stator of the machine, by a change of rotating reference frame based on a first excitation-current signal, mapped as a function of a torque setpoint of the machine and of estimated speed of rotation of the rotor, and based on a second armature-current signal proportional to an electromotive force estimated or measured by the determination means.

31. The electrical machine as claimed in claim 30, the means for determining the electromotive force comprising a winding of one or more conductive turns not supplied with electric current, wound so as to be traversed by a same magnetic flux as one of coils of the stator of the machine, the winding including a sensor of voltage generated between its two ends.

32. The electrical machine as claimed in claim 30, further comprising:
a winding of one or more conductive turns not supplied with electric current, wound so as to be traversed by a same magnetic flux as one of coils of the stator of the machine;
a sensor capable of measuring voltage generated between two ends of the winding; and
a control unit configured to compute currents to be injected into the coils of the stator of the machine, by a change of rotating reference frame based on a first excitation-current signal, mapped as a function of a torque setpoint of the machine and of estimated rotation speed of the rotor, and based on a second armature-current signal proportional to a filtered value of the voltage between the ends of the winding.

33. The reluctance electrical machine as claimed in claim 30, wherein the sensor of voltage at terminals of the winding is offset or is electrically isolated from a portion of the control unit computing the currents to be injected.

34. The reluctance electrical machine as claimed in claim 30, a winding of the stator of the machine being a tooth winding.

35. The reluctance electrical machine as claimed in claim 30, a winding of the stator of the machine being a winding of diametral type.

36. A reluctance electrical machine with tooth winding comprising:
means for estimating angular position of a rotor of the machine;
a winding of one or more conductive turns not supplied with current and wound so as to be traversed by a same magnetic flux as one of coils of a stator of the machine;
a sensor capable of measuring voltage generated between two ends of the winding; and
a control unit configured to compute currents to be injected into the coils of the stator of the machine, by a change of rotating reference frame based on a first excitation-current signal, mapped as a function of a torque setpoint of the machine and of an estimated rotation speed of the rotor, and of a second armature-current signal proportional to a filtered value of the voltage between the ends of the winding, the control unit configured to exclude from the armature current multiple frequencies of a gear-teeth frequency, the gear-teeth frequency being equal to a number of winding teeth multiplied by frequency of rotation of the rotor of the machine.
